(19) United States
(12) Patent Application Publication
(10) Pub. No.: US 2007/0210970 A1
(43) Pub. Date: Sep. 13, 2007

(54) PORTABLE WIRELESS UNIT

(75) Inventors: Kiyoshi Egawa, Tokyo (JP); Yoshio Koyanagi, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 11/573,046

(22) PCT Filed: Apr. 14, 2005
(86) PCT No.: PCT/JP05/07243

§ 371 Date: Feb. 1, 2007

(30) Foreign Application Priority Data
Aug. 5, 2004 (JP) 2004-229507

(51) Int. Cl. H01Q 1/24

(52) U.S. Cl. 343/702

(57) ABSTRACT

An object of the invention is to provide a portable radio apparatus capable of reducing a local SAR occurring when it is set close to a human head by suppressing concentration of the current flowing through an antenna element and a ground board. A portable radio apparatus according to the invention includes a first case 8; a second case 9; a plate-shaped antenna element 1 provided in the first case 8; a conductor ground board 2 provided in the second case 9 and having a ground potential; at least two feed points 3 spaced from each other, for energizing the antenna element 1; a radio circuit 5 provided on the conductor ground board 2; a power distributor 6 for outputting so as to distribute a high-frequency power input from the radio circuit 5; and a phase compensating unit 7 for compensating phases of high-frequency powers input from the power distributor in in-phase to output the compensated high-frequency powers to the at least two feed points respectively. The at least two feed points 3 supply the high-frequency powers input from the phase compensating unit 7.

### TECHNICAL FIELD

The present invention relates to an antenna device which is used in a portable radio apparatus and, more particularly, to reduction of the SAR (specific absorption rate) during a call.

### BACKGROUND ART

Among antenna devices used in conventional folding-type portable radio apparatus are ones using a case-type dipole antenna in which top and bottom cases are used as antenna elements (e.g., Patent document 1).

FIG. 15 shows the configuration of a conventional folding-type portable radio apparatus. Reference numeral 1 denotes an antenna element; 2, a ground board; 3, a feed point; 4, a hinge; and 5, a radio unit. A case-type dipole antenna is configured in such a manner that the antenna element 1 is energized by the feed point 3 which is disposed in the gap located between the hinge 4 and the ground board 2. This case-type dipole antenna exhibits good antenna characteristics in frequency bands used (800-900 MHz band, 1,500 MHz band, and 1,700-2,200 MHz band).

Patent document 1: JP-A-2003-167962

### DISCLOSURE OF THE INVENTION

### Problems to be Solved by the Invention

However, in the conventional folding-type portable radio apparatus, when the element width of the antenna element 1 is longer than the ¼ wavelength, the current distribution of the antenna device becomes as shown in a current distribution diagram of FIG. 16. That is, the current flowing through the antenna element 1 and the ground board 2 is concentrated in hinge-4-side end portions of the antenna element 1 and the ground board 2 so as to have a maximum value near the feed point 3. Therefore, when the portable radio apparatus is set close to a human head, a high local SAR may occur in the human head.

The invention has been made in view of the above circumstances, and an object of the present invention is therefore to provide a portable radio apparatus capable of reducing a local SAR occurring when it is set close to a human head by suppressing concentration of the current flowing through the antenna element and the ground board.

### MEANS FOR SOLVING THE PROBLEMS

A portable radio apparatus according to the present invention comprises a first case; a second case; a plate-shaped antenna element provided in the first case; a conductor ground board provided in the second case and having a ground potential; at least two feed points for energizing the antenna element which are spaced from each other; a radio circuit provided on the conductor ground board; a power distributor for outputting so as to distribute a high-frequency power input from the radio circuit; and a phase compensating unit for compensating phases of high-frequency powers input from the power distributor in in-phase to output the compensated high-frequency powers to the at least two feed points respectively, wherein the at least two feed points supply the high-frequency powers received from the phase compensating unit.

With this configuration, high-frequency powers produced by the power distributor and the phase compensating units are input to the at least two respective feed points in phase at the same amplitude. Therefore, the current density (per unit area) of the current flowing through the antenna element, the hinge, and the ground board can be decreased, which realizes a function of reducing a local SAR occurring in a human head when the portable radio apparatus is set close to the human head.

The portable radio apparatus according to the invention may further comprise a hinge unit which connects the first case and the second case rotatably; and the hinge unit may comprise an upper hinge which is electrically connected to the antenna element, a lower hinge which is connected to the at least two feed points, and a hinge shaft which connects the upper hinge and the lower hinge rotatably and connects them electrically, the upper hinge and the lower hinge being short-circuited with each other in the vicinities of the at least two respective feed points.

With this configuration, high-frequency powers produced by the power distributor and the phase compensating units are input to the at least two respective feed points in phase at the same amplitude. Therefore, the current is not concentrated in the hinge shaft and the current density (per unit area) of the current flowing through the antenna element, the hinge unit and the ground board can be made less localized, which realizes a function of reducing a local SAR occurring in a human head when the portable radio apparatus is set close to the human head.

In the portable radio apparatus according to the invention, the hinge unit may further comprise reactance coupling elements for connecting the upper hinge and the lower hinge in high frequencies in the vicinity of the at least two respective feed points.

With this configuration, high-frequency powers produced by the power distributor and the phase compensating units are input to the at least two respective feed points in phase at the same amplitude. Therefore, the current is not concentrated in the hinge shaft and the current density (per unit area) of the current flowing through the antenna element, the hinge unit, and the ground board can be made less localized. A function of reducing a local SAR occurring in a human head when the portable radio apparatus is set close to the human head can be realized without the need for providing short-circuiting elements for electrically connecting the hinge unit and the ground board.

In the portable radio apparatus according to the invention, the reactance elements may be such that side surfaces of cylindrical electrodes are opposed to each other.

With this configuration, high-frequency powers produced by the power distributor and the phase compensating units are input to the at least two respective feed points in phase at the same amplitude irrespective of the angle between the hinge unit and the ground board. Therefore, the current is not concentrated in the hinge shaft and the current density (per unit area) of the current flowing through the antenna element, the hinge unit, and the ground board can be made less localized. A function of reducing a local SAR occurring in a human head when the portable radio apparatus is set close to the human head can be realized without the need for providing short-circuiting elements for electrically connecting the hinge unit and the ground board.

In the portable radio apparatus according to the invention, the reactance elements may be such that convex side surfaces of semi-cylindrical electrodes or electrodes having an arc-shaped cross section are opposed to each other.

With this configuration, high-frequency powers produced by the power distributor and the phase compensating units are input to the at least two respective feed points in phase at the same amplitude in a state that the opening angle between the hinge unit and the ground board is large as in the case of a calling state. Therefore, the current is not concentrated in the hinge shaft and the current density (per unit area) of the current flowing through the antenna element, the hinge unit, and the ground board can be made less localized. A function of reducing a local SAR can be realized without the need for providing short-circuiting elements for electrically connecting the hinge unit and the ground board. Furthermore, in a state that the opening angle between the hinge unit and the ground board is small as in the case of a call-waiting state, the coupling between the electrodes of each reactance coupling element is weak. Therefore, current is concentrated in the hinge shaft and hence the hinge shaft operates as a radiation element. A function of attaining stable characteristics in both of a call-waiting state and a calling state can thus be realized.

### ADVANTAGE OF THE INVENTION

The portable radio apparatus according to the invention can reduce a local SAR occurring when it is set close to a human head by suppressing concentration of the current flowing through the antenna element and the ground board.

### BRIEF DESCRIPTION OF THE DRAWINGS

FIG. 1 shows the configuration of a portable radio apparatus according to a first embodiment of the invention.

FIG. 2 shows the configuration of the portable radio apparatus according to the first embodiment of the invention in which a phase compensating unit is removed.

FIG. 3 is a current distribution diagram of the portable radio apparatus according to the first embodiment of the invention in which the phase compensating unit is removed.

FIG. 4 is a proximal magnetic field distribution diagram of the portable radio apparatus according to the first embodiment of the invention in which the phase compensating unit is removed.

FIG. 5 shows the configuration of a portable radio apparatus according to a second embodiment of the invention.

FIG. 6 is a current distribution diagram of the portable radio apparatus according to the second embodiment of the invention.

FIG. 7 shows the configuration of a portable radio apparatus according to a first modification of the second embodiment of the invention.

FIG. 8 is a current distribution diagram of the portable radio apparatus according to the first modification of the second embodiment of the invention.

FIG. 9 shows the configuration of a portable radio apparatus according to a second modification of the second embodiment of the invention.

FIG. 10 shows the configuration of a portable radio apparatus according to a third modification of the second embodiment of the invention.

FIG. 11 shows the configuration of the portable radio apparatus according to the third modification of the second embodiment of the invention which is folded.

FIG. 12 is a current distribution diagram of the portable radio apparatus according to the third modification of the second embodiment of the invention which is folded.

FIG. 13 shows the configuration of a portable radio apparatus which is different from the portable radio apparatus according to the second embodiment of the invention in the hinge structure.

FIG. 14 shows the configuration, in a folded state, of the portable radio apparatus which is different from the portable radio apparatus according to the second embodiment of the invention in the hinge structure.

FIG. 15 shows the configuration of a conventional folding-type portable radio terminal.

FIG. 16 is a current distribution diagram of the conventional portable radio terminal.

FIG. 17 is a proximal magnetic field distribution diagram of the conventional portable radio terminal.

### DESCRIPTION OF SYMBOLS

1: Antenna element
2: Ground board
3: Feed point
4: Hinge
5: Radio unit
6: Power distributor
7: Phase compensating unit
8: First case
9: Second case
10: Upper hinge
11: Hinge shaft
12: Lower hinge
13: Short-circuiting element
14, 15, 16: Reactance coupling element
17: Horizontal hinge
18: Energization base

### BEST MODE FOR CARRYING OUT THE INVENTION

### First Embodiment

A portable radio apparatus according to a first embodiment of the present invention will be hereinafter described in detail with reference to the drawings.

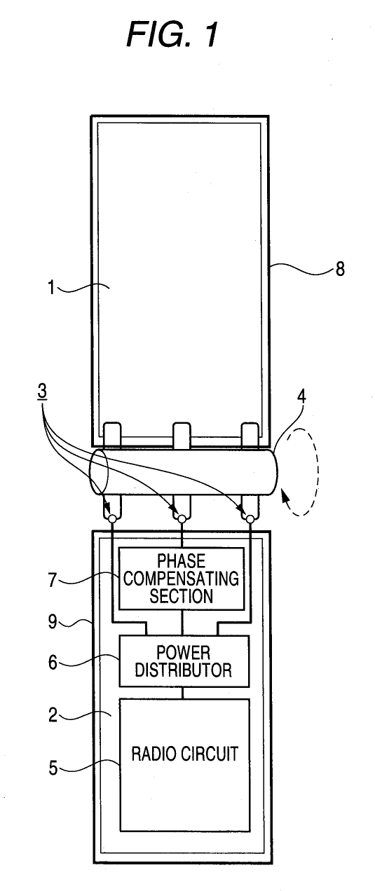

FIG. 1 shows the configuration of the portable radio apparatus according to the first embodiment of the invention. The portable radio apparatus according to the first embodiment of the invention includes an antenna element 1 which is a flat-plate conductor provided in a first case 8; a ground board 2 having a ground pattern of a circuit board provided in a second case 9; a hinge 4 which connects the first case 8 and the second case 9 in a rotatable manner and which is a conductor electrically connected to the antenna element 1; at least two feed points 3 which are disposed between the hinge 4 and the ground board 2 so as to be spaced from each other and energize the antenna element 1; a radio circuit 5 provided on the ground board 2; a power distributor 6 which equally distributes a high-frequency power supplied from the radio circuit 5; and a phase compensating unit 7 which supplies at least two feed points 3 with in-phase high-frequency powers, respectively, that originate from the power distributor 6.

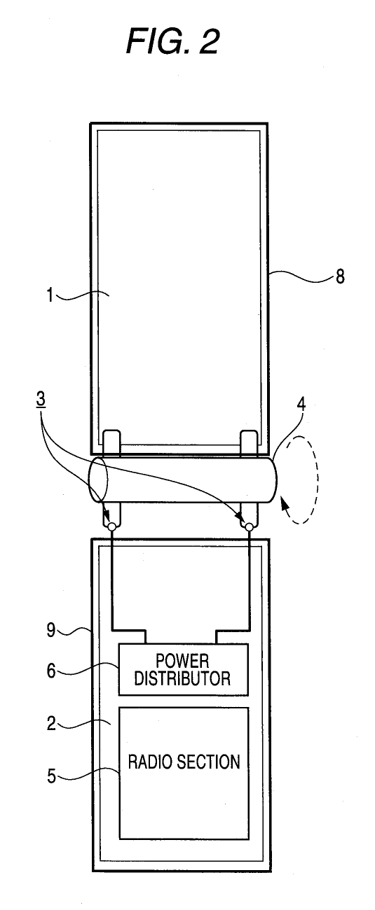

FIG. 2 shows the configuration of the portable radio apparatus according to the first embodiment of the invention in which the phase compensating unit is removed. The conduction paths from the power distributor 6 to the feed points 3 may be used as the phase compensating unit 7 by distributing two high-frequency powers produced by the power distributor 6 to the two respective feed points 3 in a right-left symmetrical manner.

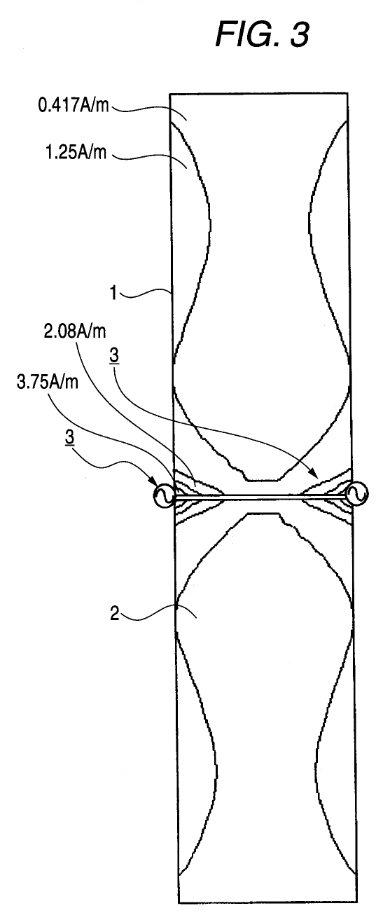

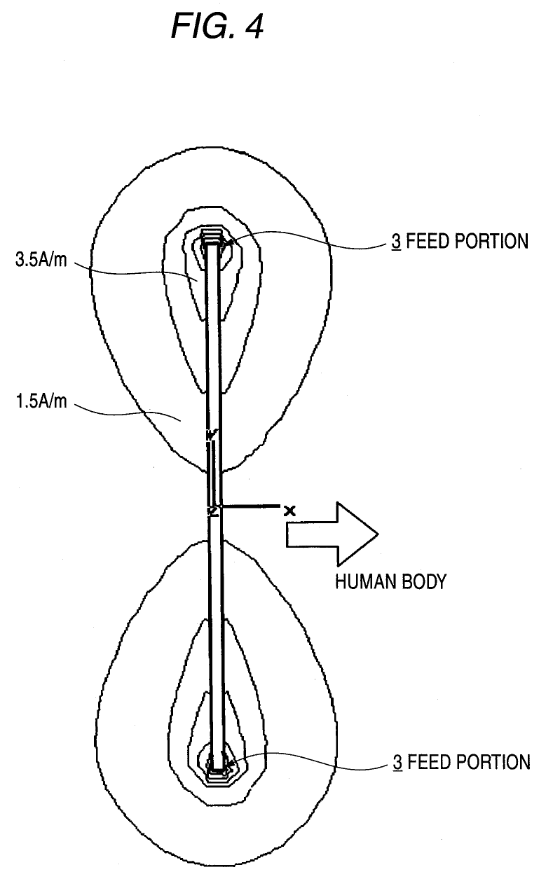

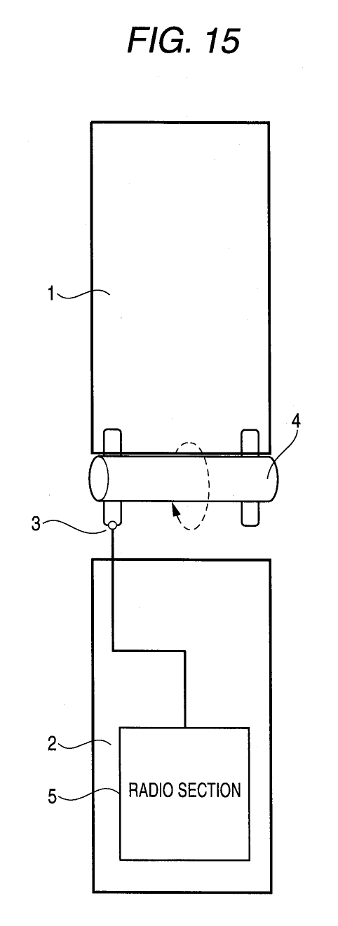

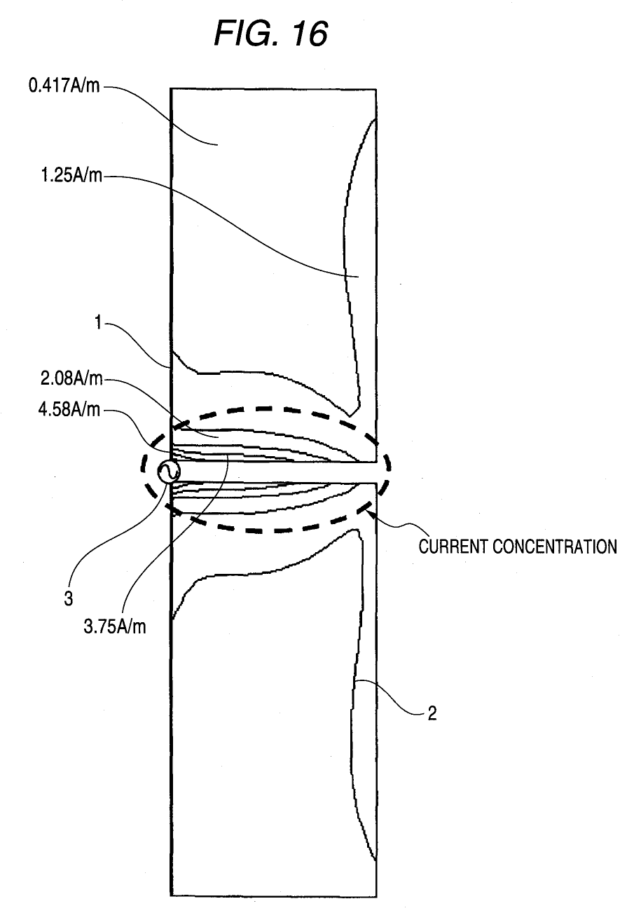

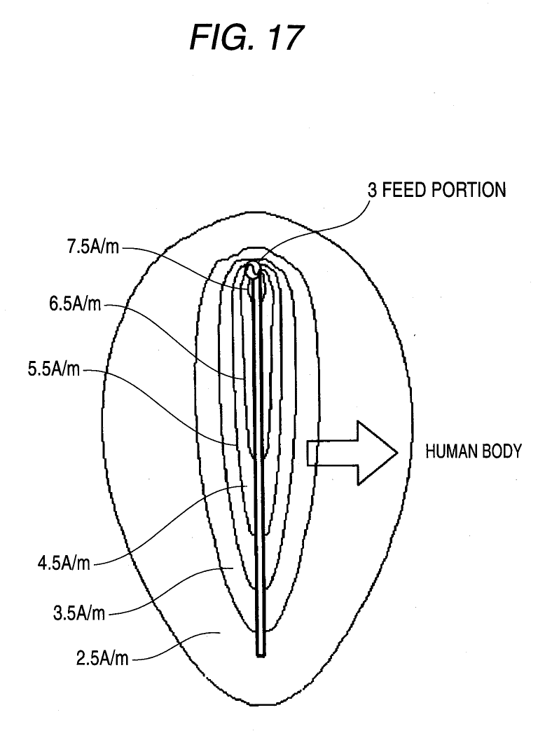

Differences between the current distribution of the antenna device of the conventional portable radio apparatus shown in FIG. 15 and that of the antenna device of the portable radio apparatus according to the first embodiment of the invention shown in FIG. 2 will be described below with reference to FIG. 3 which is a current distribution diagram of the antenna device of the portable radio apparatus according to the first embodiment of the invention, FIG. 16 which is a current distribution diagram of the antenna device of the conventional portable radio apparatus, FIG. 4 which is a magnetic field distribution diagram of the antenna device of the portable radio apparatus according to the first embodiment of the invention, and FIG. 17 which is a magnetic field distribution diagram of the antenna device of the conventional portable radio apparatus. The current distribution diagrams of FIGS. 3 and 16 and the magnetic field distribution diagrams of FIGS. 4 and 17 are diagrams corresponding to configurations in which the antenna element 1, the ground board 2, and the feed point(s) are simplified and are results of numerical analyses using a finite integration method. A current of 1 A is input to the feed point 3 shown in FIGS. 16 and 17 and currents of 0.5 A are input the respective feed points shown in FIGS. 3 and 4. The current density is higher when equi-current-density lines are denser.

In the conventional portable radio apparatus, if it is assumed that the antenna element 1 is 90 mm in length and the ground board 2 is 95 mm in length, the element width of the antenna element 1 is longer than the ¼ wavelength if the use frequency is about 1,900 MHz and the current flowing through the antenna element 1 and the ground board 2 is concentrated in hinge-4-side end portions of the antenna element 1 and the ground board 2 so as to have a maximum value near the feed point 3 as shown in the current distribution diagram of FIG. 16.

The magnetic field distribution diagram of FIG. 17 shows a proximate magnetic field in the cross-section taken perpendicularly to the vertical direction of the conventional portable radio apparatus of FIG. 15. It is seen that a magnetic field stronger than 5 A/m is generated near the feed point. Therefore, when the portable radio apparatus is set close to a human head, a high local SAR occurs in the human head because of the strong magnetic field that is concentrated near the feed point.

In the portable radio apparatus according to the first embodiment of the invention, as for the current flowing through the antenna element 1 and the ground board 2, the current flowing through each feed point 3 is a half of the current flowing through the feed point 3 in the conventional technique as shown in the current distribution diagram of FIG. 3, whereby the current density (per unit area) of the current flowing through the antenna element 1 and the ground board 2 can be made less localized. On the other hand, the radiation efficiency of the antenna device is not lowered because the total current flowing through the antenna element 1 and the ground board 2 is the same as in the conventional portable terminal having only one feed point.

The magnetic field distribution diagram of FIG. 4 shows a proximate magnetic field in the cross-section taken perpendicularly to the vertical direction of the portable radio apparatus according to the first embodiment of the invention shown in FIG. 2. As in the case of the current distribution diagram of FIG. 3, the strength of the magnetic field is halved near each feed point and hence the amount of radiation of electromagnetic waves toward a human body is also halved. An SAR distribution occurring when the portable radio apparatus is set close to a human head is made less localized and hence the local SAR can be reduced.

In the portable radio apparatus according to the first embodiment of the invention, currents that are generated by the power distributor 6 through equal division and input, in phase, to the input ends of the respective feed points 3 by the phase compensating unit 7 are supplied to the antenna element 1 from the at least two feed points 3. Therefore, the current density (per unit area) of the current flowing through the antenna element 1 and the ground board 2 can be made less localized. As a result, a local SAR occurring in a human head when the portable radio apparatus is set close to the human head can be reduced.

### Second Embodiment

A portable radio apparatus according to a second embodiment of the invention will be described below with reference to the drawings.

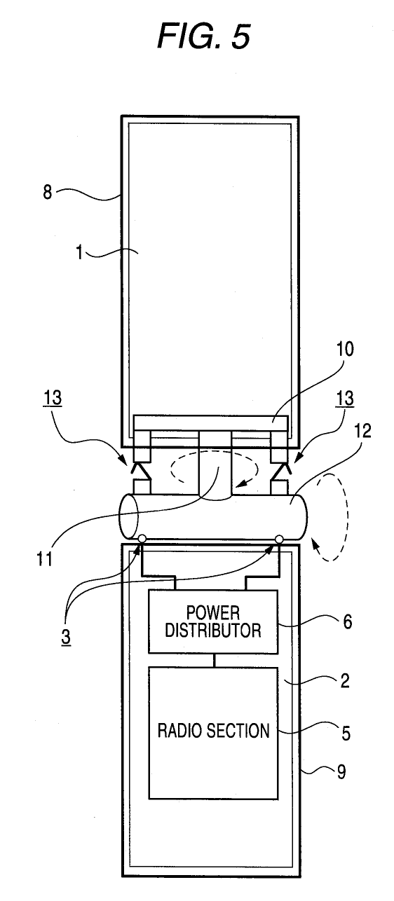

FIG. 5 shows the configuration of the portable radio apparatus according to the second embodiment of the invention. Components having the same components in the portable radio apparatus according to the first embodiment will be given the same reference symbols and will not be described.

A hinge unit of the portable radio apparatus according to the second embodiment of the invention includes an upper hinge 10 which is connected to the antenna element 1, a lower hinge 12 which is connected to the feed points 3, and a hinge shaft 11 which connects the first case 8 and the second case 9 in such a manner that they can rotate about the vertical direction of the portable radio apparatus and which electrically connects the upper hinge 10 and the lower hinge 12. Short-circuiting elements 13 for connecting the upper hinge 10 and the lower hinge 12 are disposed between both ends of the upper hinge 10 and both ends of the lower hinge 12 in the vicinities of the respective feed points 3. Alternatively, the hinge shaft 11 may be configured so as not to rotate.

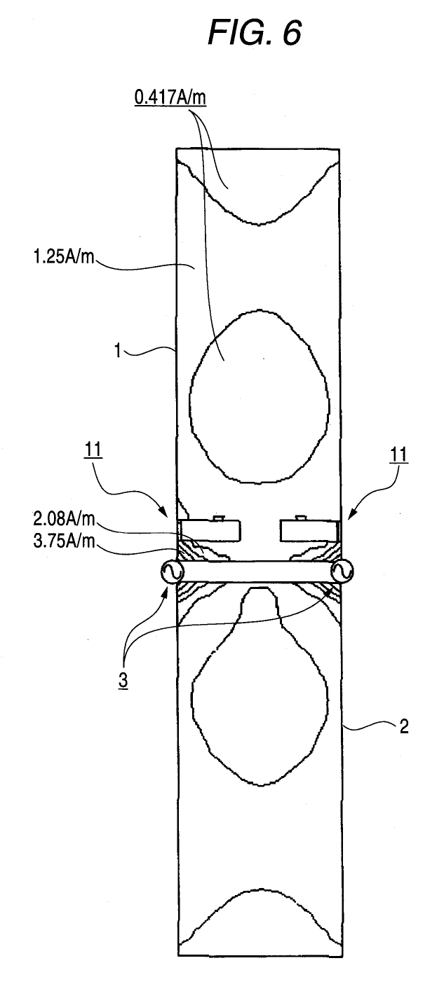

A high-frequency power flowing through the lower hinge 12 and the ground board 2 is divided by the power distributor 6 into two equal parts, which are supplied to the feed points 3 in phase at the same amplitude. By supplying the two divisional high-frequency powers to the feed points 3 in a right-left symmetrical manner, the conduction paths from the power distributor 6 to the feed points 3 are used as the phase compensating unit 7. Since the short-circuiting elements 13 are disposed between both ends of the upper hinge 10 and both ends of the lower hinge 12, currents flow to the upper hinge 10 and the antenna element 1 without concentration of a high-frequency power in the hinge shaft 11. FIG. 6 is a current distribution diagram of the portable radio apparatus according to the second embodiment of the invention. As in the case of the current distribution diagram of FIG. 3, the current flowing through each feed point 3 is a half of the current flowing through the feed point 3 in the conventional technique and the current density (per unit area) of the current flowing through the antenna element 1 and the ground board 2 can be made less localized. As a result, this embodiment can reduce a local SAR occurring in a human head when the portable radio apparatus is set close to the human head while accommodating a complex hinge structure.

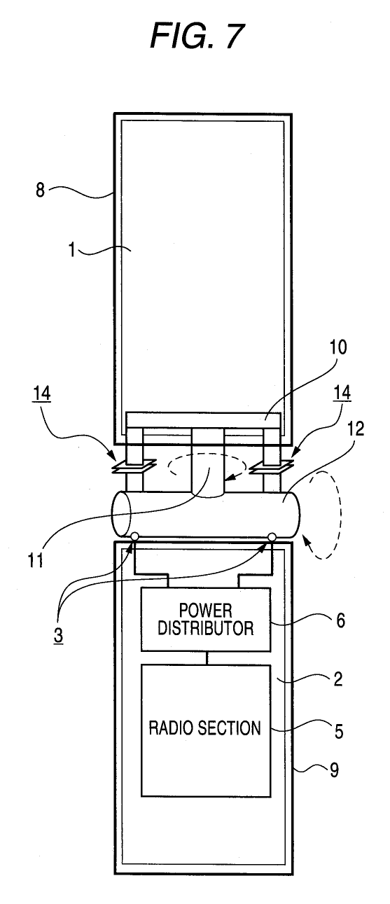

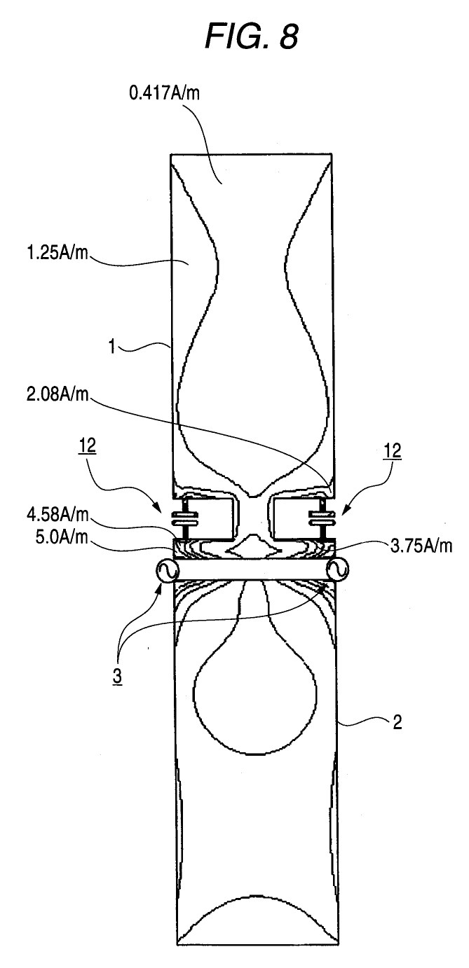

The portable radio apparatus according to the second embodiment employs the short-circuiting elements 13 as means for connecting the upper hinge 10 and the lower hinge 12. Alternatively, reactance coupling elements 14 shown in FIG. 7 may be used instead of the short-circuiting elements 13. FIG. 8 is a current distribution diagram of the portable terminal using the reactance coupling elements 14, which is similar to FIG. 6 which is the current distribution diagram of the case that the short-circuiting elements 13 are used. Reduction of the local SAR can be realized by a simple structure. As for the size of the reactance coupling elements 14 shown in FIG. 7, for example, two 6-mm-square conductor plates are spaced from each other by 1 mm, in which case the reactance coupling elements 14 shown in FIG. 7 provide a capacitance of about 0.3 pF.

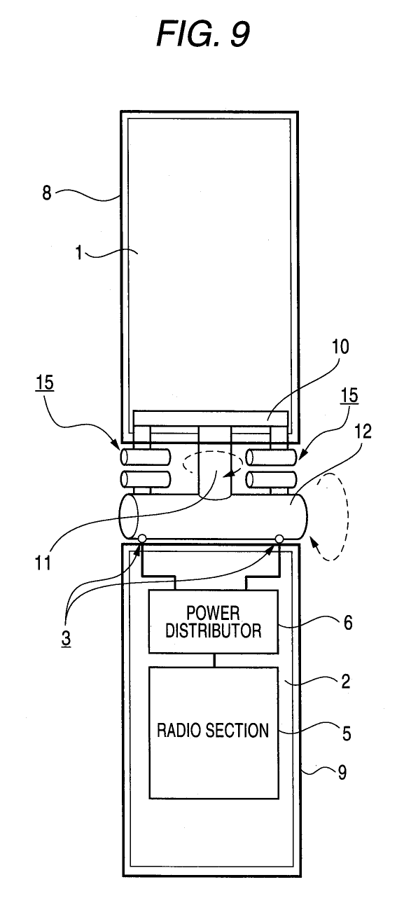

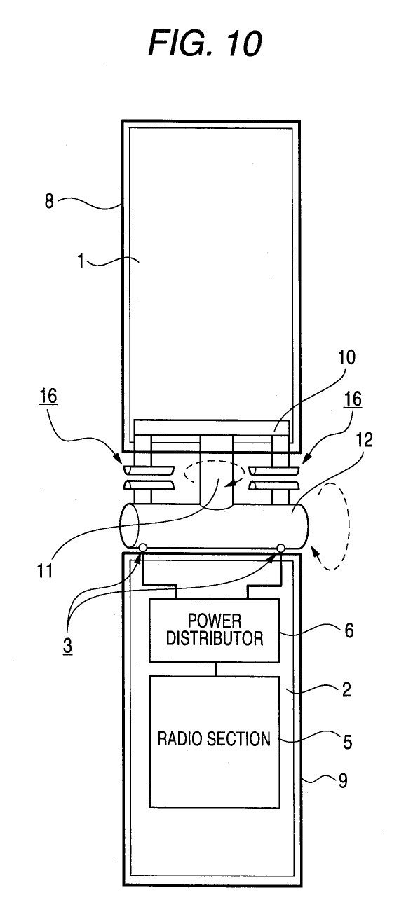

FIG. 9 shows another modification in which the short-circuiting elements 13 shown in FIG. 5 are replaced by reactance coupling elements 15 in which the side surfaces of cylindrical electrodes are opposed to each other. FIG. 10 shows still another modification in which the short-circuiting elements 13 shown in FIG. 5 are replaced by reactance coupling elements 16 in which the convex side surfaces of semi-cylindrical electrodes or electrodes having an arc-shaped cross section are opposed to each other.

As shown in FIG. 9, the reactance coupling elements 15 in which the side surfaces of the cylindrical electrodes are opposed to each other can provide a constant capacitance that is independent of the angle of the lower hinge 12 when the lower hinge 12 is rotated. Therefore, a local SAR occurring when the portable radio apparatus is set close to a human head can be reduced, irrespective of the angle of a portable radio terminal using folding-type cases.

As shown in FIG. 10, the reactance coupling elements 16 in which the convex side surfaces of the semi-cylindrical electrodes or the electrodes having an arc-shaped cross section are opposed to each other can provide a constant capacitance like the reactance coupling elements 15 shown in FIG. 9 when a user makes a call by opening the portable radio apparatus in which case the opening angle of the lower hinge 12 is large. Therefore, a local SAR occurring when a portable radio apparatus in such a state is set close to a human head can be reduced.

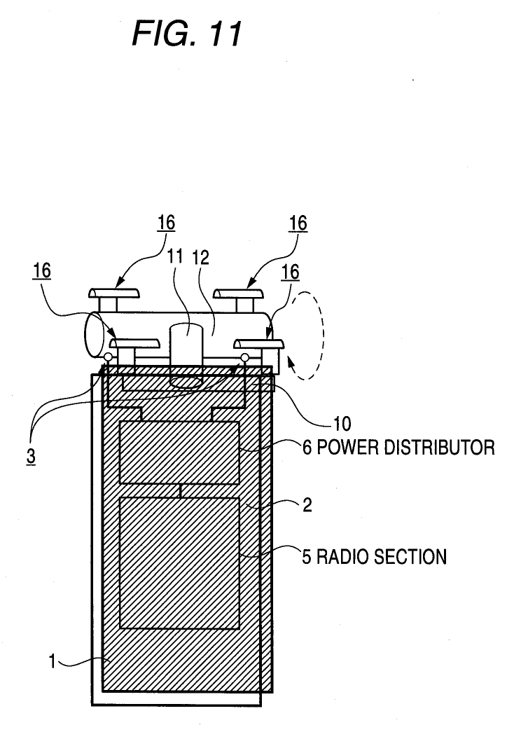

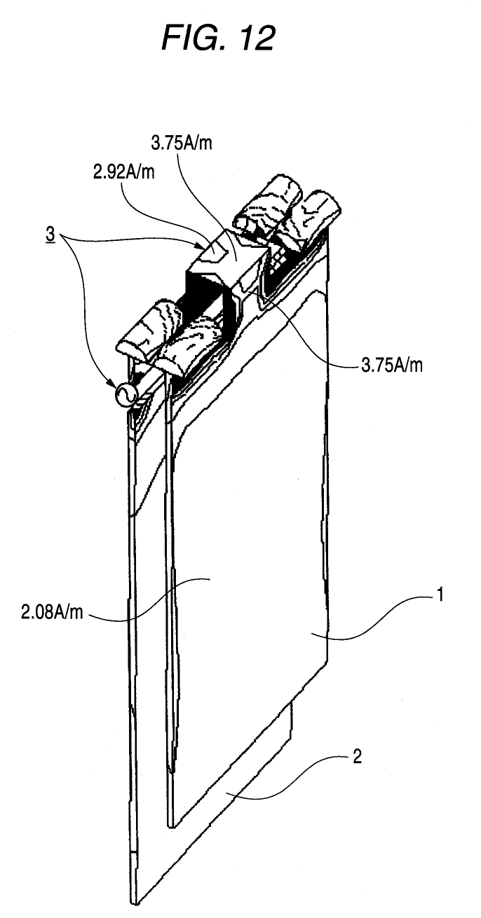

FIG. 11 shows the configuration of the portable radio apparatus using the reactance coupling elements 16 shown in FIG. 10 in a state that the portable radio apparatus is closed (folded) in which case the opening angle of the lower hinge 12 is small. In this state, the reactance coupling elements 16 in which the convex side surfaces of the semi-cylindrical electrodes or the electrodes having an arc-shaped cross section are opposed to each other provide no capacitance. Therefore, as shown in FIG. 12 which is a current distribution diagram of the portable radio apparatus which is folded, current is concentrated in the hinge shaft 11 and hence the hinge shaft 11 operates as a radiation element. In this manner, switching between antennas can be performed automatically in accordance with the use state of the portable radio apparatus.

As for the size of the reactance coupling elements 15 in which the side surfaces of the cylindrical electrodes are opposed to each other and which are used in the portable radio apparatus of FIG. 9 and the size of the reactance coupling elements 16 in which the convex side surfaces of the semi-cylindrical electrodes or the electrodes having an arc-shaped cross section are opposed to each other and which are used in the portable radio apparatus of FIG. 10, for example, two cylindrical (or semi-cylindrical) conductors that are 5 mm in diameter are spaced from each other by 1 mm. In this case, the reactance coupling elements 15 and 16 provide a capacitance of about 0.3 pF, which is equal to the capacitance provided by the reactance coupling elements 14.

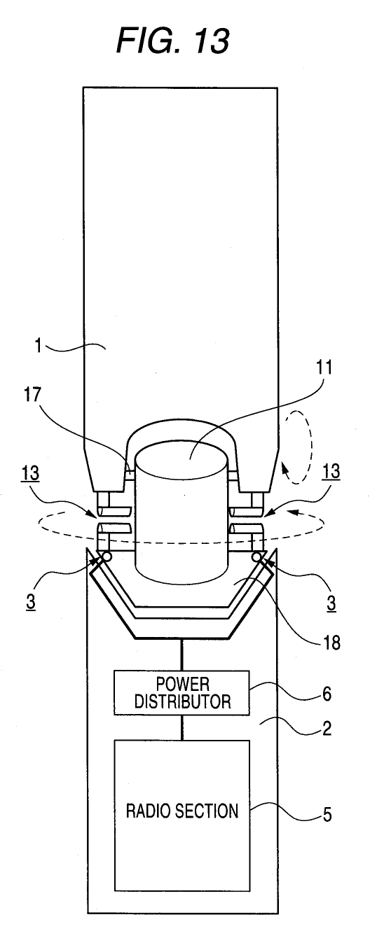

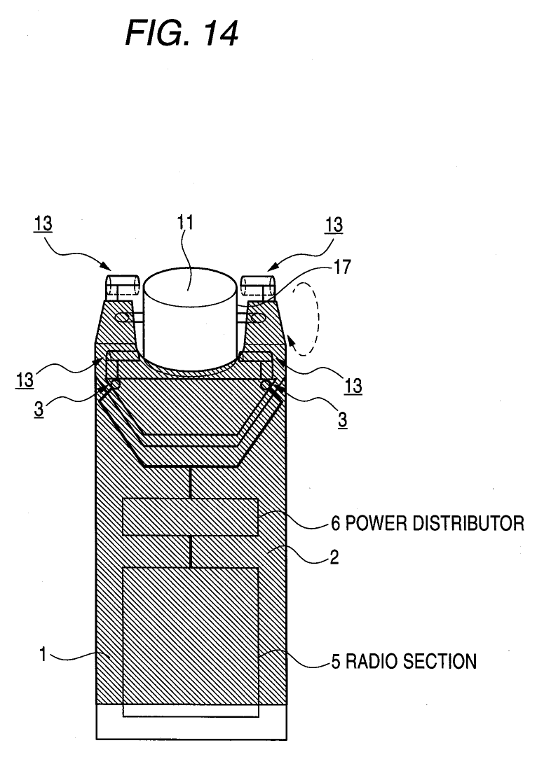

FIGS. 13 and 14 show another modification of the hinge unit. FIG. 13 shows a portable radio apparatus which is opened. Horizontal hinges 17 whose axes extend in the horizontal direction are connected to the flat-plate conductor 1 and a hinge shaft 11. A radio signal coming from the radio unit 5 is distributed by the power distributor 6 so as to travel in two directions and be supplied to both ends of an energization base 18 which is connected to the hinge shaft 11. Reactance coupling elements 16 in which the convex side surfaces of semi-cylindrical electrodes or electrodes having an arc-shaped cross section are opposed to each other and which connect the top case 5 and the energization base 17 in high frequencies are disposed between both ends of the top case 5 and the energization base 17. The hinge unit having the above structure can provide the same advantage as that shown in FIG. 11 does. FIG. 14 shows the portable ratio apparatus which is folded. In this state, this hinge unit can provide the same advantage as that shown in FIG. 11 and being in the same state does.

The invention has been described above in detail in the form of the particular embodiments. However, it is apparent to a person skilled in the art that various modifications and corrections are possible without departing from the spirit and scope of the invention.

This application is based on Japanese Patent Application No. 2004-229507 filed on Aug. 5, 2004, the disclosure of which is incorporated by reference herein.

### INDUSTRIAL APPLICABILITY

The portable radio apparatus according to the invention provides an advantage that a local SAR occurring when the portable radio apparatus is set close to a human head can be reduced by suppressing concentration of the current flowing through the antenna element and the ground board. As such, the portable radio apparatus according to the invention is useful when applied to a field which relates to SAR reduction during a call.

1. A portable radio apparatus, comprising:
a first case;
a second case;
a plate-shaped antenna element that is provided in the first case;
a conductor ground board that is provided in the second case and has a ground potential;
at least two feed points that energize the antenna element and are spaced to each other;
a radio circuit that is provided on the conductor ground board;
a power distributor that outputs so as to distribute a high-frequency power input from the radio circuit; and
a phase compensating unit that compensates phases of high-frequency powers input from the power distributor in in-phase to output the compensated high-frequency powers to the at least two feed points respectively,
wherein the at least two feed points supply the high-frequency powers input from the phase compensating unit to the antenna element.

2. The portable radio apparatus according to claim 1, further comprising a hinge unit that connects the first case and the second case rotatably,
wherein the hinge unit includes:
an upper hinge which is electrically connected to the antenna element;
a lower hinge which is connected to the at least two feed points; and
a hinge shaft which connects the upper hinge and the lower hinge rotatably and electrically; and
wherein the upper hinge and the lower hinge are short-circuited with each other in the vicinities of the at least two respective feed points.

3. The portable radio apparatus according to claim 2, wherein the hinge unit further comprises reactance coupling elements that connects the upper hinge and the lower hinge in high frequencies in the vicinity of the at least two respective feed points.

4. The portable radio apparatus according to claim 3, wherein the reactance coupling elements have electrode shapes in which side surfaces of cylindrical electrodes are opposed to each other.

5. The portable radio apparatus according to claim 3, wherein the reactance coupling elements have electrode shapes in which convex sides of side surfaces or convex sides of arc-shaped cross sections of semi-cylindrical electrodes are opposed to each other.
